(19) United States
(12) Patent Application Publication
(10) Pub. No.: US 2021/0178347 A1
(43) Pub. Date: Jun. 17, 2021

(54) CHEMISTRY VESSEL AGITATOR

(71) Applicant: BWXT Isotope Technology Group, Inc., Lynchburg, VA (US)

(72) Inventors: Benjamin Isaiah Bishop, Forest (VA); Curtis Graham Hamilton, Lynchburg (VA); Ronald Clifton Watson, Forest, VA (US)

(21) Appl. No.: 17/032,911

(22) Filed: Sep. 25, 2020

Related U.S. Application Data
(60) Provisional application No. 62/906,901, filed on Sep. 27, 2019.

(51) Int. Cl. B01F 7/00; B01F 7/18; B01F 15/02; B01F 15/00

(52) U.S. Cl. CPC B01F 7/007; B01F 7/0025; B01F 7/00641; B01F 2215/0036; B01F 15/0274; B01F 15/00448; B01F 2015/0059; B01F 7/18

(57) ABSTRACT

An agitator device for mixing materials, including a containment vessel defining an interior volume, a hollow shaft having an upper end, a lower end, and a central bore along its length, the lower end extending downwardly into the interior volume of the containment vessel, the hollow shaft being rotatable with respect to the containment vessel, and a takeout tube having an upper end and a lower end, wherein the takeout tube is disposed within the central bore of the hollow shaft so that the lower end of the takeout tube is in fluid communication with the interior volume of the containment vessel.

### CLAIM OF PRIORITY

This application claims priority to U.S. Provisional Application No. 62/906,901, filed Sep. 27, 2019, the entire disclosure of which is incorporated by reference herein.

### TECHNICAL FIELD

The presently-disclosed invention relates generally to agitation devices for vessels and methods of use thereof for mixing and stirring materials to produce a chemical reaction and, more specifically, to systems and methods of use thereof that facilitate removal of the end product from the vessel after the chemical reaction.

### BACKGROUND

Agitator devices for use in mixing elements, especially for mixing chemicals, are well known in the art. Existing agitator devices typically include a drain port, or tap, on a lower portion of the device for draining the end product of the agitation process from the corresponding vessel. Because such a tap is necessarily at a low portion of the device to allow for adequate draining, the tap poses an issue with regard to leakage of the vessel's contents. This issue is exacerbated when the chemistry vessel being agitated is used in a highly radioactive environment, which can lead to degradation of the seal within the tap. In other known embodiments, the agitation process can be ceased to allow for product removal via a dip tube that is passed downwardly through a port in the lid of the vessel. However, securing the agitation process during withdrawal of the product can lead to the undesired separation of the elements within the vessel at the time of withdrawal.

As such, there at least remains a need, therefore, for agitation devices and methods for mixing materials and facilitating removal of the product from the device while still agitating.

### SUMMARY OF INVENTION

One embodiment of the present disclosure provides an agitator device for mixing materials, including a containment vessel defining an interior volume, a hollow shaft having an upper end, a lower end, and defining a central bore along its length, the lower end extending downwardly into the interior volume of the containment vessel, the hollow shaft being rotatable with respect to the containment vessel, and a takeout tube having an upper end, a lower end, and a central bore along its length, wherein the takeout tube is disposed within the central bore of the hollow shaft so that the lower end of the takeout tube is in fluid communication with the interior volume of the containment vessel and the upper end of the takeout tube extends axially outwardly beyond the upper portion of the hollow shaft.

Another embodiment of the present disclosure provides an agitator device for mixing materials in a containment vessel defining an interior volume, a hollow shaft having an upper end, a lower end, and defining a central bore along its length, the drive assembly being operably connected to the upper end of the hollow shaft, wherein the hollow shaft is rotatable with respect to the drive assembly; and a takeout tube having an upper end, a lower end, and a central bore along its length, wherein the takeout tube is slidably receivable within the central bore of the hollow shaft so that the lower end of the takeout tube is in fluid communication with the interior volume of the containment vessel.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

The invention now will be described more fully hereinafter with reference to the accompanying drawings, in which some, but not, all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1 is a perspective view of an agitation device in accordance with an embodiment of the present disclosure;

FIG. 2 is a schematic cross-sectional view of the agitation device shown in FIG. 1, mounted to a containment vessel;

FIG. 3 is a cross-sectional view of the agitation device shown in FIG. 2, taken along line 3-3 of FIG. 2;

FIG. 4 is a cross-sectional view of the agitation device shown in FIG. 2, taken along line 4-4 of FIG. 2; and

FIG. 5 is a cross-sectional view of the agitation device shown in FIG. 2, taken along line 5-5 of FIG. 2.

Repeat use of reference characters in the present specification and drawings is intended to represent same or analogous features or elements of the invention according to the disclosure.

### DESCRIPTION OF THE PREFERRED EMBODIMENTS

Reference will now be made to presently preferred embodiments of the invention, one or more examples of which are illustrated in the accompanying drawings. Each example is provided by way of explanation, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, terms referring to a direction or a position relative to the orientation of the fuel-fired heating appliance, such as but not limited to “vertical,” “horizontal,” “upper,” “lower,” “above,” or “below,” refer to directions and relative positions with respect to the appliance's orientation in its normal intended operation, as indicated in the Figures herein. Thus, for instance, the terms “vertical” and “upper” refer to the vertical direction and relative upper position in the perspectives of the Figures and should be understood in that context, even with respect to an appliance that may be disposed in a different orientation.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

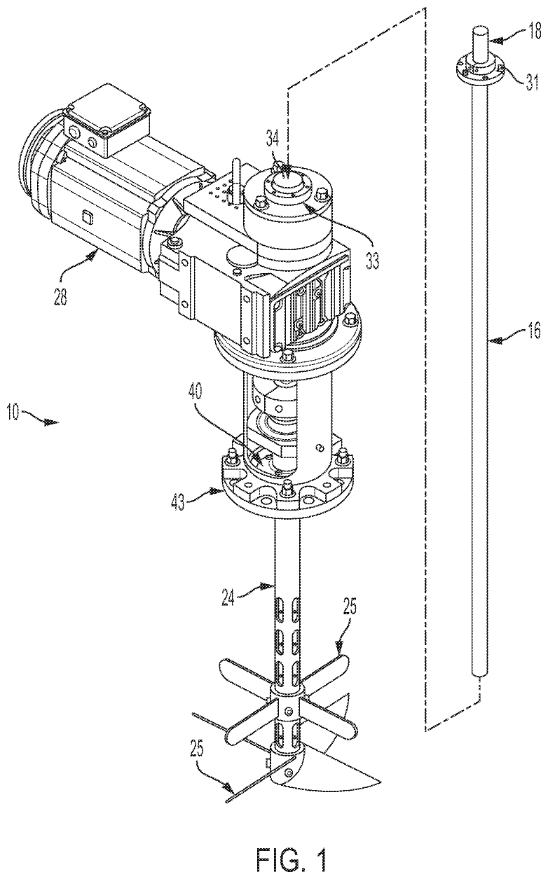

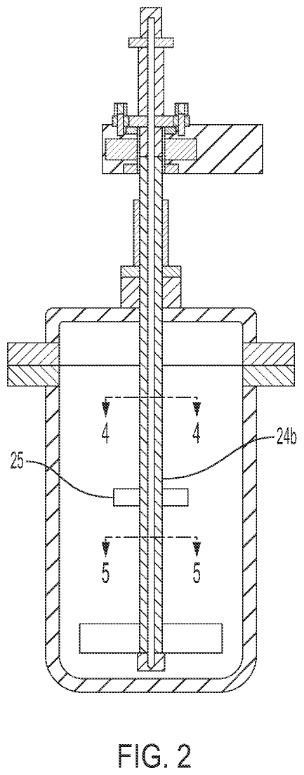

Referring now to FIGS. 1 and 2, an example embodiment of an agitator device 10 in accordance with the present invention includes a containment vessel 12 having a lid 14, a takeout tube 16, preferably rigid, with a plumbing connection 18 at one end, a spool piece 20 with removable end cap 22, a hollow shaft 24, and an optional filter or screen 26 (FIG. 2). Note, the agitator device 10 shown in the schematic diagram at FIG. 2 differs slightly from the embodiment shown in FIG. 1. As discussed in greater detail below, the embodiment shown in FIG. 1 differs primarily from that shown in FIG. 2 in that the spool piece 20 is omitted. The hollow shaft 24 is operatively connected to a drive assembly 28, or gear box, with an output hub 30 that is open on both ends. The drive assembly 28 connection to the hollow shaft 24 is necessary to impart rotational forces on the hollow shaft 24. The details of how the hollow shaft 24 is supported have many known solutions and are, therefore, not further discussed in the present disclosure.

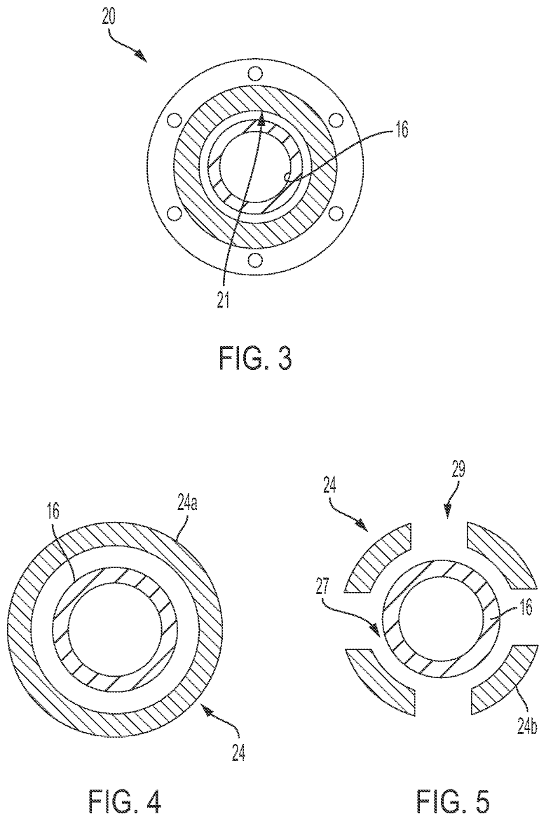

As shown, the hollow shaft 24 preferably includes paddles 25 (although screw forms, vanes, propellers, etc., may also be used) extending radially outwardly from an outer surface thereof in order to agitate the materials in the vessel 12 as the hollow shaft 24 is rotated. Note, two different forms of paddles 25 are shown in FIG. 1. The spool piece 20 (embodiment in FIG. 2) is mounted to the drive assembly 28 but does not rotate with respect to the containment vessel 12. The spool piece 20 supports the takeout tube 16 without imparting rotational forces to the takeout tube 16. An opening 21 in the spool piece 20 is sufficiently large to allow the takeout tube 16 to be inserted (a lead-in taper may be included), but small enough to ensure proper alignment of the takeout tube 16 through the hollow shaft 24, as best seen in FIG. 3. The takeout tube 16 may incorporate a soft bushing (not shown) that provides a seal for preventing gases from entering or leaving the containment vessel 12 through the hollow shaft 24 connection. Note, in alternate embodiments a dip tube with an integrated pump may be used rather than the above described configuration.

As noted above, in the embodiment shown in FIG. 1, the spool piece 20 can be removed and the hollow shaft 24 can be extended upwardly through the drive assembly 28. The top end of the hollow shaft 24 can be sealed with a removable end cap 34, similar to end cap 22, when the takeout tube 16 is not in place. As shown, a shaft seal 40 is disposed around the outer surface of the hollow shaft 24 to present the release of gasses and liquids where the hollow shaft 24 penetrates the containment vessel. As the spool is omitted in the presently described embodiment, a takeout tube mount 33 is provided on the upper surface of the drive assembly 28. After the takeout tube 16 is inserted in the hallow shaft 24, the takeout tube 16 is secured to the tube mount 33 by a flange 31 that is disposed on the upper end of the takeout tube 16. Preferably a bushing (not shown), or bearing arrangement, is utilized in this alternate arrangement to maintain alignment of the takeout tube 16 when the agitation device 10 is operating. A mounting flange 43 is provided on the agitator device 10 to allow mounting the device to the lid 14 of the corresponding containment vessel 12. In yet another embodiment, the takeout tube 16 can be replaced by, or combined with, an instrumentation probe (not shown) that would allow measurement of mixture conditions (e.g., temperature, pH) or allow for the addition of extra materials.

Referring additionally to FIG. 4, the hollow shaft 24 has sufficient clearance to allow rotation of the hollow shaft 24 with the takeout tube 16 fully inserted therein. The upper portion of the sidewall 24a of the hollow shaft 24 is solid above the maximum height of the chemical product within the vessel 12, but is preferably not solid (e.g., slotted or includes apertures 29) at the lower portion of the sidewall 24b, as shown in FIG. 5. As shown, the slotted configuration aides in the circulation of the product within the vessel 12 and assists in the cleaning of the hollow shaft 24 after the product is withdrawn from the vessel 12. The design of the lower hollow shaft portion 24b includes features that prevent accumulation of particles that may exist in the product material. For example, the clearance 27 between the lower portion 24b of the hollow shaft 24 and the takeout tube 16, and the slots 29, may be designed to be larger than the largest anticipated product particles. A filter 26 may be mounted on the bottom end of the hollow shaft 24 to prevent large particles (e.g., larger than one-half the takeout tube 16 inner diameter) from clogging the takeout tube 16.

The takeout tube 16 may be inserted at the beginning of the chemistry batch agitation run or it may be inserted at the completion of the chemistry batch agitation run. If the takeout tube 16 is inserted during the chemistry run, the takeout tube 16 may be pressurized with a gas to prevent reactants from entering the takeout tube 16 and potentially depositing products that may clog the takeout tube 16. In either case, the top of the spool piece 20 should be sealed to prevent leakage of gaseous reaction products from the vessel 12. If the takeout tube 16 is inserted after completion of chemical reactions, then the top of the spool piece 20 may be sealed with an easily removable cap 22 during the process.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. An agitator device for mixing materials, comprising:
a containment vessel defining an interior volume;
a hollow shaft having an upper end, a lower end, and defining a central bore along its length, the lower end extending downwardly into the interior volume of the containment vessel, and the hollow shaft being rotatable with respect to the containment vessel; and
a takeout tube having an upper end, a lower end, and a central bore along its length,
wherein the takeout tube is disposed within the central bore of the hollow shaft so that the lower end of the takeout tube is in fluid communication with the interior volume of the containment vessel and the upper end of the takeout tube extends axially outwardly beyond the upper portion of the hollow shaft.

2. The agitator device of claim 1, wherein the hollow shaft further comprises a plurality of one of paddles, spiral forms, vanes, and propellers extending radially outwardly from an outer surface of the lower portion of the hollow shaft.

3. The agitator device of claim 2, wherein the lower portion of the hollow shaft further comprises one or more axially extending slots extending from an inner surface to the outer surface of the lower portion of the hollow shaft.

4. The agitator device of claim 2, further comprising a spool piece that is non-rotatably affixed to an upper portion of the drive assembly, and the upper portion of the takeout tube extends axially outwardly beyond an upper portion of the spool piece.

5. The agitator device of claim 2, wherein the containment vessel further comprises a lid disposed on an upper portion of the containment vessel, and the hollow shaft and the takeout tube pass through the lid.

6. The agitator device of claim 2, further comprising a cap that is received on the upper portion of the takeout tube.

7. The agitator device of claim 2, further comprising a drive assembly that is operably connected to the hollow shaft and configured to selectively rotate the hollow shaft.

8. An agitator device for mixing materials in a containment vessel defining an interior volume, comprising:
a hollow shaft having an upper end, a lower end, and defining a central bore along its length,
a drive assembly, the drive assembly being operably connected to the upper end of the hollow shaft, wherein the hollow shaft is rotatable with respect to the drive assembly; and
a takeout tube having an upper end, a lower end, and a central bore along its length,
wherein the takeout tube is slidably receivable within the central bore of the hollow shaft so that the lower end of the takeout tube is in fluid communication with the interior volume of the containment vessel.

9. The agitator device of claim 8, wherein the upper end of the takeout tube extends axially outwardly beyond the upper portion of the hollow shaft.

10. The agitator device of claim 8, wherein the hollow shaft further comprises a plurality of one of paddles, spiral forms, vanes, and propellers extending radially outwardly from an outer surface of the lower portion of the hollow shaft.

11. The agitator device of claim 10, wherein the lower portion of the hollow shaft further comprises one or more apertures extending from an inner surface to the outer surface of the lower portion of the hollow shaft.

12. The agitator device of claim 10, further comprising a spool piece that is non-rotatably affixed to an upper portion of the drive assembly, and the upper portion of the takeout tube extends axially outwardly beyond an upper portion of the spool piece.

13. The agitator device of claim 10, wherein the containment vessel further comprises a lid disposed on an upper portion of the containment vessel, and the hollow shaft and the takeout tube pass through the lid.

14. The agitator device of claim 10, further comprising a cap that is received on the upper portion of the takeout tube.
